(19) United States
(12) Patent Application Publication
(10) Pub. No.: US 2010/0162600 A1
(43) Pub. Date: Jul. 1, 2010

(54) Electric Fire

(76) Inventors: Martin Betz, Co. Louth (DE); Wolfram Fischer, Co. Louth (DE); Muiris Flynn, Co.Meath (DE)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/087,909

(22) PCT Filed: Jan. 29, 2007
(86) PCT No.: PCT/EP2007/050856

§ 371 Date: Jul. 17, 2008

(30) Foreign Application Priority Data
Jan. 31, 2006 (GB) 0601903.8

(51) Int. Cl. F21S 10/04

(52) U.S. Cl. 40/428

(57) ABSTRACT

An electric fire is described. By providing the fire in plastic and forming it from a kit of individual housings that inter-engage with one another to form the completed fire the time required for assembly of the fire is reduced greatly. Also described is a spacer arrangement for a fire, for use in circumstances where the fire is too small for the opening which it is to be located in. Also described is a reflector screen formed using a hot foil stamping technique. Finally, a moulded fuel bed is described which can be used to simulate pebble or glass effects.

### FIELD OF THE INVENTION

The invention relates to electric fires. In a first embodiment the invention relates to an electric fire provided as a kit of parts, more particularly to an electric fire fabricated from moulded plastic components. In another embodiment the invention relates to a reflective screen for electric fires, the reflective screen providing a visual representation of flames. In a further embodiment the invention relates to a fuel bed for an electric fire.

### BACKGROUND ART

Within the field of electric fires it is well known to provide fires of differing shapes and forms. Traditionally the electric fire was provided as a substitute for the conventional “real” fire and as such had to be dimensioned to fit into the opening provided within the fireplace. The installation of the fireplace is predominately conducted by the purchaser of the fire, i.e. not a skilled installer of such devices. Although the dimensions of fireplace opening are relatively constant, there is always the possibility that the purchased electric fire could be found on installation to be too small for the opening where it is required to be located. In these circumstances, the aesthetic effect is such that the fire can be perceived as being lost within the largeness of the fireplace where it is located. This also creates the problem of the possibility of drafts within the room as the flue is free to vent to the room. Both these issues can be addressed by fabricating a surround for the fire to ensure that the fire fully locates within the area defined by the opening of the fireplace. There is therefore a need for an electric fire whose exterior dimension can be modified by a non-skilled user on installation of the fire at the home.

Irrespective of the dimensions of the fire, heretofore the electric fire has been fabricated in the main from metal materials. The number of components required for complete manufacture an electric fire is quite large and the time required to assemble these components into a completed product can take a skilled operator up to about 80 minutes. Within this context, and with the desire to provide more and more fires at a lower price, there is a requirement to improve the manufacturing process used to fabricate such fires.

A further factor associated with the traditional electric fire, is that irrespective of the time required to assemble such units, the technology used in providing the basic components of the fire has remained static for some time. Although developments have been made in certain areas of the fire, such as those described in our earlier British Patent, GB 2180927, the simplest of electric fires include a heating element, a light source used to illuminate an artificial fuel bed and a reflective screen that is upstanding from the fuel bed and is used to simulate flame effects. Heretofore, the reflective element has been provided as a metal substrate pre-plated with brass or chrome depending on the colour required. Due to the nature of the materials used and the limitations associated with the plating techniques, the provision of such reflective screens contributes substantial elements of cost towards the final cost of the fire. Furthermore, the design and shape of the screen is limited to that achievable using the metal substrate material. There is therefore a need to provide a reflective screen that can be mass produced at a lower cost than that traditionally available.

Within the context of the fuel bed, it is known to provide a log effect and/or coal effect by stacking individual components on a base substrate. Alternative simulations include the known techniques of using broken glass or pebbles. The fabrication of such known fuel beds has required the provision and arrangement of the individual pieces (either the coals, logs, glass or pebbles) on the substrate. This may be done in a temporary fashion which suffers in that the arrangement may become disarranged through transportation of the fire or a permanent fashion whereupon the “fuel” is permanently affixed using glue or the like to the supporting substrate. This can be a tedious exercise and also results in each fire having a uniquely arranged fuel bed, which may not necessarily provide the desired overall aesthetic effect or consistency required from a quality assurance perspective. With the use of glass fragments or pieces there is a further need from the perspective of safety to ensure that there are no sharp glass edges, and it is therefore necessary to take the additional step of grinding the individual pieces of glass.

It will therefore be appreciated that there are a number of areas which are problematic with regard to the standard electric fire. There is as a result a need to provide a fire that addresses one or more of these problems so as to provide a completed assembled fire in a cost effective manner.

### SUMMARY

Accordingly the invention provides an electric fire that is fabricated from a plurality of sub-assemblies, the sub-assemblies being formed from individual plastic moulded parts that are each configured to enable a snap-fit of the sub-assemblies together to form a completed fire.

In another aspect of the invention an electric fire reflector is provided, the reflector being formed from a plastic substrate having a foil laminate formed thereon, the provision of the laminate on the substrate forming a pattern on the substrate surface of areas of high reflectivity separated by areas of low reflectivity.

Desirably the foil laminate is formed on the plastic substrate using a hot foil stamping technique. The foil is typically selected from a brass and/or chrome metal foil. Other multi-coloured foils may also be used to provide a different colouration pattern on the reflector substrate. The process of foil stamping involves the application of foil, a special film-backed material, to the plastic substrate and a stamping of a heated die onto the foil, making it adhere to the surface leaving the design of the die on the substrate. It is therefore easier to achieve and also to change the design of the pattern on the substrate and also quicker to form the substrates. The foil stamping can be combined with embossing to create a more striking 3D image for the reflector. This embossing affect could also be achieved by prior moulding the plastic substrate to the desired configuration and then applying the foil—as opposed to forming the raised surfaces subsequent to the application of the foil.

Such hot foil stamping techniques have been found by the present inventors to be advantageous in the formation of the reflector in that the patterns achievable on the substrate are easily alterable in that the design is dictated by the die and not the foil itself.

As mentioned above, the substrate may be moulded to provide a textured surface which will provide a diffuse effect when illuminated with light. The substrate may also be formed as a flexible sheet, enabling the provision of the curved reflector. By using a mould to form the plastic substrate it is also possible to incorporate items such as mounting brackets as integral components of the reflector.

In another aspect of the invention an insert for increasing the area of the façade of an electric fire is provided. The insert may be provided as a single sheet having an inner perimeter and outer perimeter, the distance between the inner perimeter and outer perimeter defining the area of the insert and wherein the inner perimeter is dimensioned to co-operate and mate with the façade of the fire, a mating of the inner perimeter with the façade increasing the area of the façade and enabling a closure of the opening within which the fire is located.

In such an embodiment the insert may be provided with a plurality of template cut lines, the template cut lines being arranged at different distances from the inner perimeter and providing a template for a user to cut the insert so as to reduce the area of the insert if so required to fit the opening available for the fire.

In another embodiment of the insert, a self-assembly kit is provided, the kit enabling an enlarging of the area of the façade of an electric fire, the kit including a plurality of inter-connecting members, the members providing horizontal and vertical extensions which when interconnected with one another and coupled to the façade of the fire, increase the area of the façade thereby enabling a closing of the opening of the fireplace where the fire is located.

The members typically include at least two vertical members and one horizontal members which when assembled the vertical members provide an extension for the left and right side of the façade of the fire, the horizontal member provides an extension for the top of the façade, each of the two vertical members being coupled to respective ends of the horizontal members, the members serving to provide a frame about three sides of the façade of the fire.

In a further aspect of the invention an electric fire is provided having an artificial fuel bed, the fuel bed being formed from a moulded plastic substrate having integrally formed on an upper surface thereof a plurality of individual raised protrusions. It will be appreciated that the protrusions replicate the effect provided by the fuel pieces such as glass or pebbles in an artificial fuel bed. The number and individual dimensions of each of the protrusions may be predefined as part of the mould design process. Desirably the moulded plastic is formed from a polycarbonate or polypropylene resin. A colouring of the fuel bed may be achieved by varying the colour of the light source used to illuminate the fuel bed or may alternatively or in addition be achieved by colouring the plastic fuel bed. A further technique usable in the colouring of the fuel bed is the application of a coloured filter to a lower surface of the substrate, the filter serving the purposes of varying the colour of the incident light through the substrate.

These and other features of the present invention will be understood better with reference to the following Figures which describe exemplary non-limiting embodiments of the invention.

### BRIEF DESCRIPTION OF THE DRAWINGS

FIG. 1 is an exploded view of a disassembled fire in accordance with a first embodiment of the invention.

FIG. 2 is a perspective view from the front and side of an assembled fire.

FIG. 3 is a view from the side of the fire of FIG. 2.

FIG. 4 is a view from the front of the fire of FIG. 3.

FIG. 5 is an exploded view from the front of the fire of FIGS. 1 to 3 with a selection of inserts that may be used in combination with the fire.

FIG. 6 is a view similar to FIG. 5 but from the rear.

FIG. 7 is an exploded view from the front showing a partial assembly of two of the inserts.

FIG. 8 is a view of two inserts being assembled together.

FIG. 9 shows a reflector according to an embodiment of the invention.

FIG. 10 is shows a fuel bed according to the teaching of the invention.

FIG. 11 shows a fuel bed from above (FIG. 11a) and from the side (FIG. 11b) according to a second embodiment of the invention.

### DETAILED DESCRIPTION OF THE DRAWINGS

The invention will now be described with exemplary embodiment of the invention.

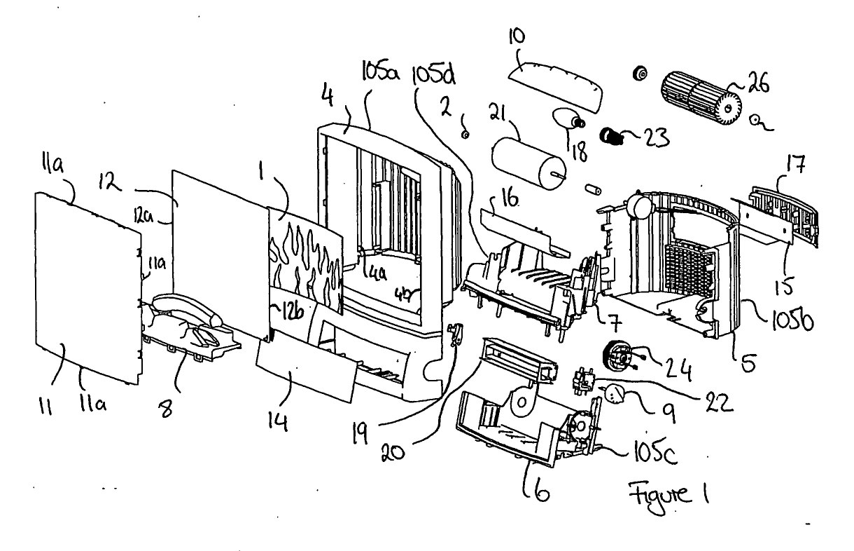

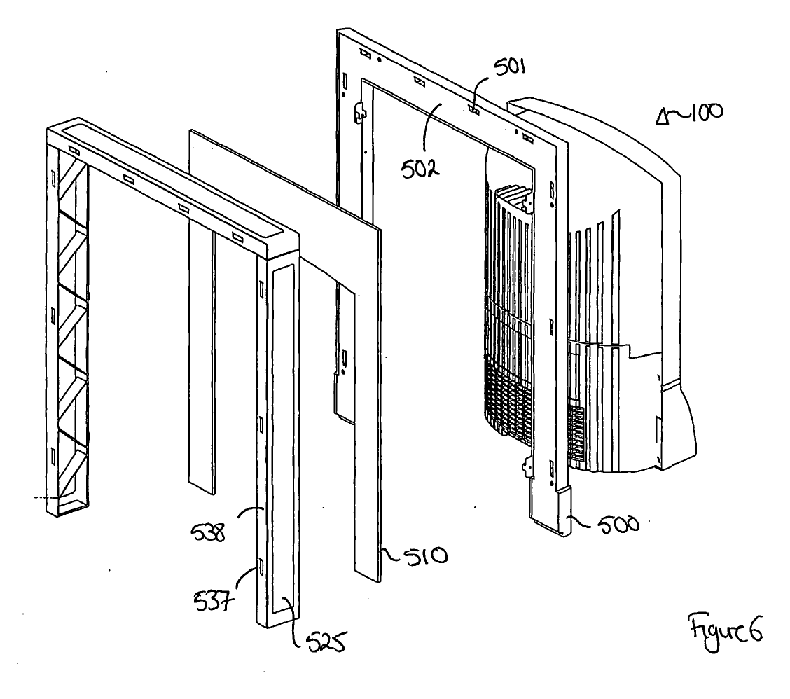

As shown in FIG. 1, an electric fire 100 is provided that is fabricated from a plurality of sub-assemblies 105. The sub-assemblies 105 are formed from individual plastic moulded parts that are each configured to enable a snap-fit of the sub-assemblies together to form a completed fire. In the embodiment of FIGS. 1, 4 such sub-assemblies 105a, 105b, 105c, 105d are provided. By forming the fire from such assemblies the time required to completely assemble a fire is reduced from about 80 minutes to about 20 minutes with the result that about 4 fires can be fabricated using the methodology of the sub-assemblies in the time required traditionally to fabricate one fire using the teachings of the prior art.

In the embodiment shown in the exploded view of FIG. 1, a plurality of components are identifiable. These components may be differentiated into different categories such as housing components which form the sub-assemblies of the fire. The housing components include a front housing 4 (105a), a rear housing 5 (105b), a blower housing 6 (105c), and a rotisserie bracket housing 7 (105d). These housing components are fabricated from a plastics material through a moulding or extrusion process and are configured to provide support for other components of the fire. By integrally moulding connectors or mating profiles for other components of the fire to be received into each of these housing and then securing the components and the individual housings together using integrally formed arrangements, the time required to fully assemble a fire is drastically reduced.

Desirably the fire is assembled in a series of steps, which will be set forth as follows in a time sequence.

Step 1: Mounting of Front Housing Components into Front Housing 105a.

A flame panel 1 is mountable in a rear portion of the front housing by means of a snap fit clip arrangement. A rear glass screen 12 is placed in front of the panel 1. This is positioned by sliding the screen upwardly from below the flame panel along two receiver channels 4a, 4b, which are configured to receive the side walls 12a, 12b of the screen 12. By at least partially mirroring a surface of the rear glass panel 12, it is possible to increase the depth of view appearance to a viewer to the front of the fire. Horizontally displaced in front and at a lower portion of the rear glass panel, a fuel effect panel 8 (configured to simulate fuel of the fire) is provided. This is snap fit into the housing and a rear lip of same serves to retain the rear glass screen 12. A front glass screen 11 is provided in a vertical orientation, substantially parallel to the rear glass screen in front of the fuel effect panel. By providing the front screen in a moulded polycarbonate it is possible to integrally form clip components 11a which co-operate with suitably positioned mating components in the housing 105a. A grill element 14 is provided so as to be mountable in a suitably dimensioned aperture provided in a lower portion of the front of the front housing 4.

### Step 2: Mounting of Blower Housing Components to Blower Housing 105c

The blower housing 6 (105c) is configured to receive the parts required for an air blower, that when the fire is assembled are located behind the grill 14. These parts include first and second control knobs 9, 13 that are located on opposite sides of the fire. The control knobs are configured to provide for a turning on and off of the fire flame effect and provide for different heat settings. In the embodiment shown in FIG. 1, the first controller 22 provides, in a multi-position switch, means for iteratively increasing the heat output of the fire whereas a second controller, a thermostat 19, is provided by which means the heat output of the fire is controllable according to the ambient room temperature. In this arrangement, the thermostat can be positioned to a desired temperature and once the heat in the room has reached this temperature, the heating element will turn off automatically. A heating element 20, typically having a value output of about 2 kW, is located in the blower housing, mounting being achieved by the provision of support members integrally moulded in the plastic of the blower housing 6. A blower drum 26 is coupled to a motor 24 which because of the vibration achieved during operation may be optimally additionally secured by means of screws to the blower housing 105c.

### Step 3: Mounting of Components to Rotisserie Housing 105d

In order to provide lighting to the interior portion of the fire, thereby illuminating both the flame panel 1 and the fuel bed 8, a lighting arrangement is provided in a lower portion of the fire. The lighting arrangement includes a bulb 18 that is electrically housed in a bulb holder 23. A baffle 10 serves to break up and distribute the light to the desired level for illumination of the regions above. In order to provide for a flicker effect, a rotisserie 21 is provided that is coupled to a motor 25. The rotation of the rotisserie serves to break up the light that is then incident on the flame panel 1, so as to give the effect of flame flicker. As the panel is segregated into regions of high reflectivity and low reflectivity, a combination of the varying incident light and the rotation of the rotisserie serves to provide a realistic flame effect. A fuel bed reflector 16 ensures that light emitted by the bulb is equally distributed across the fuel bed 8. All these components are received in moulded receiving portions provided on the rotisserie bracket housing 7.

### Step 4: Final Interlocking of Parts.

Once assembled, this bracket housing 7 is then presented and mated with the blower housing, and the two are receivable in a lower portion of the rear housing 5. A fully assembled rear housing with the rotisserie bracket housing and blower housing are then presented to the front housing and mated through inter-engagement of parts integrally formed in each of the housings. When inter-engaged the rear housing is located relative to the front housing such that the heat generated by the element in the blower housing may be distributed to the front of the fire through the grill element.

By providing the sub-assemblies from moulded plastic parts the inter-engagement of the parts is simplified as they may lock together using parts that are integrally formed during the moulding process. This mating does not require the provision of additional screws or the like, but such screws may be used without departing from the scope of the invention. Typically a snap fit arrangement is provided and will be considered adequate to secure the front housing to the rear housing, thereby fully enclosing the interior portion of the fire. A rear hatch 17 is provided to enable easy access to the bulb, in the eventuality that the bulb needs replacing.

It will be understood that the assembly of the fire involves a sequence of steps which have been described above with reference to four exemplary sequential steps. It will be understood that the final step has to be last and step 2 before step 3, but that step 1 could be done after steps 2 and 3 are completed. Individual components are assembled in their respective housings and then the housing are brought together to form the final snap-fit inter-engagement to fully assemble the fire. Once assembled only the front and rear housing portions are visible from the outside of the fire with the two other housing components being mounted within.

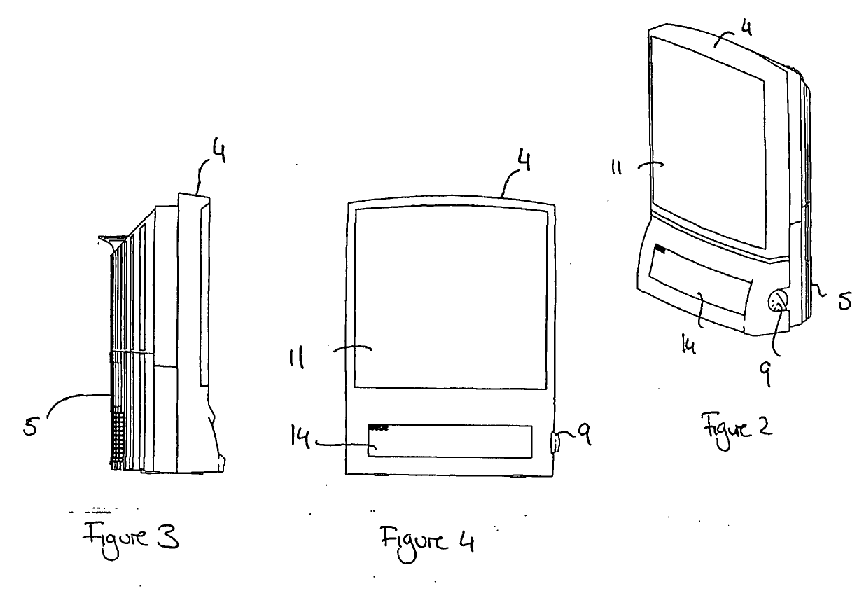

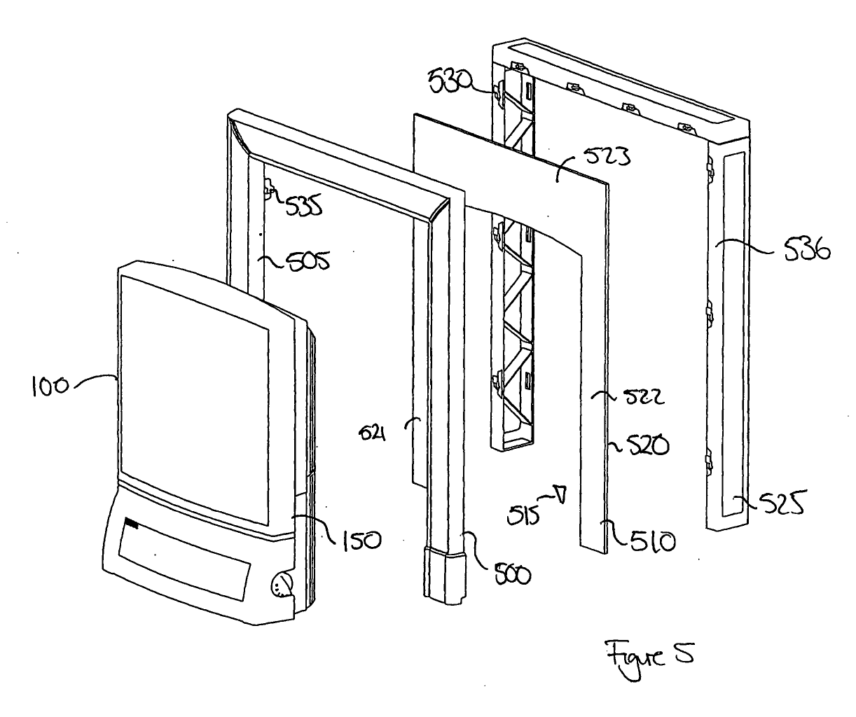

FIG. 2 shows such an assembled fire in a perspective view from the front and side, whereas FIGS. 3 and 4 show side view and front views respectively with typical dimensions illustrated. It will be understood from an inspection of these dimensions that a fire according to the teachings of the invention is a compact article, of the order of 40 cm×52 cm and having a depth of 11 cm. This is much smaller than typical known fires which are typically of the order of 110 cm×120 and having a depth of 22 cm. As the usual location for such fires is in a traditional fire place—which comes with a standard opening sizing defined in accordance with BS 1251 it will be understood that the location of a fire according to the invention in such a known fireplace would result in a dwarfing of the fire in the fire place opening.

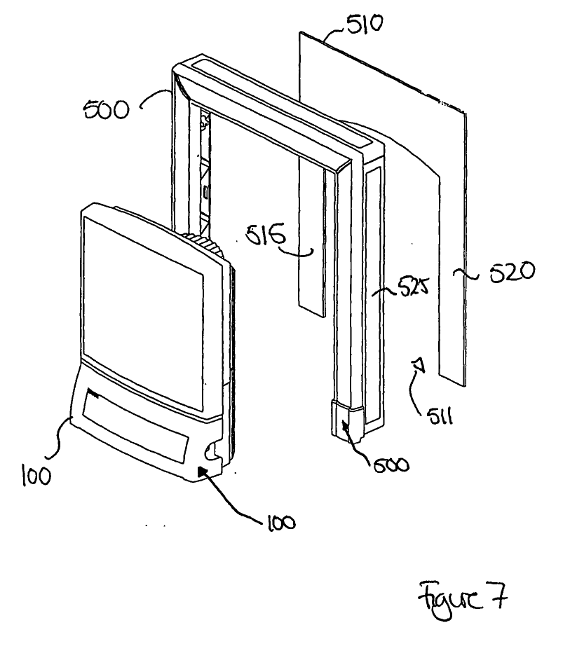

The invention addresses these problems in a second embodiment by providing a surround extension which is configured to expand the width and height occupied by the fire. An exploded view of multiple components of such an extension is shown in FIG. 5. All or none of these components can be used in combination with the fire 100.

In the view of FIG. 5, three separate components are described. The first, a fire surround 500 is of the type known for insert fires and may be gilded or otherwise decorated to provide a frame about the fire 100. In order to fill the gap between the interior surfaces 505 of the surround and the exterior sides 150 of the fire 100, a planar panel spacer 510 may be utilised. This panel has an interior cut out portion 515 whose dimensions substantially correspond with the exterior dimensions of the fire. When mounted relative to the fire, the fire is seated within the interior portion of the panel 510. The width of the surface of the panel 510 is such that its exterior surface 520 will mate with the interior surface 505 of the surround, using for example retainers 535 that are moulded on the frame. In order to increase the depth of the fire, an insert filler 525 may be provided. This insert filler 525 is provided with a plurality of interconnects 530 which are configured to match and mate with corresponding interconnects 501 on the surround 500. Typically these are provided as moulded projections 530 on the front surface 536 of the insert filler 525 which interlock with apertures 501 provided on the rear surface 502 of the frame 500 (shown in the rear view of FIG. 6). Where the depth provided by one insert filler 525 is not sufficient, two or more insert fillers can be placed back to back and mated together by interlocking the interconnects 530 of a first insert filler with apertures 537 provided on a rear surface 538 of another insert filler.

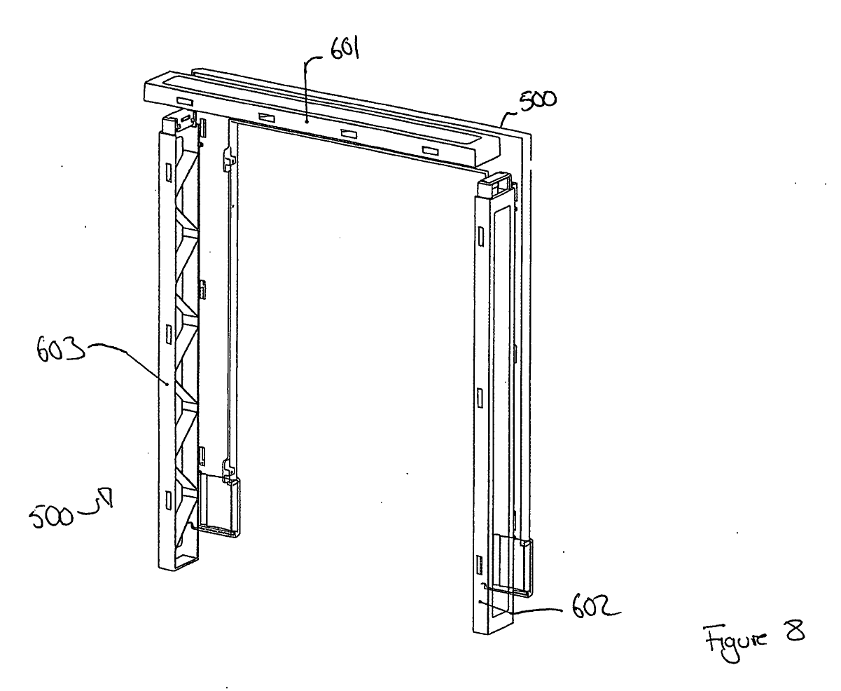

FIG. 7 shows an assembled insert filler 525 with a frame 500 from which it can be seen the depth increase that is achievable using such an arrangement.

FIG. 8 shows how the insert filler may be provided as three separate parts, which are provided to the user as individual parts but which can be assembled by the user at the location of installation by interlocking each of the two vertical members 602, 603 with a horizontal member 601 and fixing these to the frame 500.

The frame 500 can also be provided as a solid piece or as a kit of parts for assembly by the user. Advantages of providing the components in a breakdown form for assembly by the user include the fact that the breakdown form is less bulky and therefore easier to transport and store. By providing a kit in this manner it is possible to pack the surround in a smaller area, making it easier and cheaper to transport. It is also possible to provide the user with a plurality of parts of different dimensions so that they can then self-assemble the parts together at their home to fit the desired area. Those parts not required may then be discarded.

Similarly the spacer 510 can be provided with some assembly required by the user. For example as described hereinbefore it is provided as a solid piece with the external dimensions pre-defined. Alternatively a plurality of cut or break lines can be provided so as to enable a user to break the spacer to fit the desired opening where the fire is located. The inner cut-out portion 515 which is dimensioned to sit about the exterior portion of the fire 100 is a fixed size and will not require modification. With two vertical panels 521, 522 extending upwardly from the ground and joined at the top by a vertical panel 523, the surround resembles an upside down U shape. Desirably the width and height of these panels is adjustable so that the surround can be configured to fully encompass the area defined by different fire place opening. This adjustment can be provided by having a plurality of break lines defined in vertical and horizontal planes of the surround such that the user can then reduce the dimension of the surround to fit their fire.

The surround extension or self assembly kit enables an enlarging of the area of the façade of an electric fire. When assembled it enables an increase of the area of the façade of the fire thereby enabling a closing of the opening of the fireplace where the fire is located.

Depending on the circumstances of the installation, all or none of these three components 500, 510, 525 may be used with the fire 100.

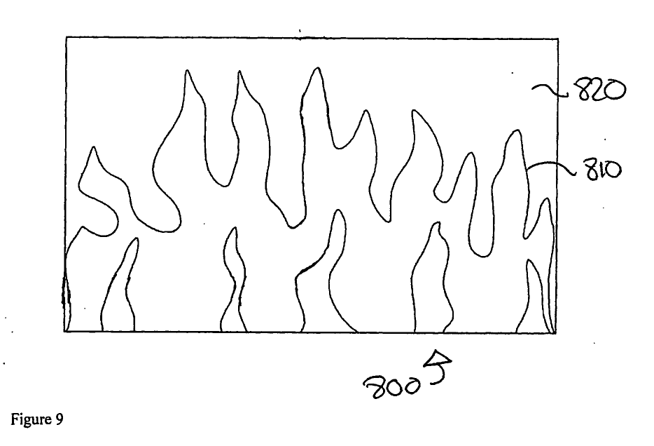

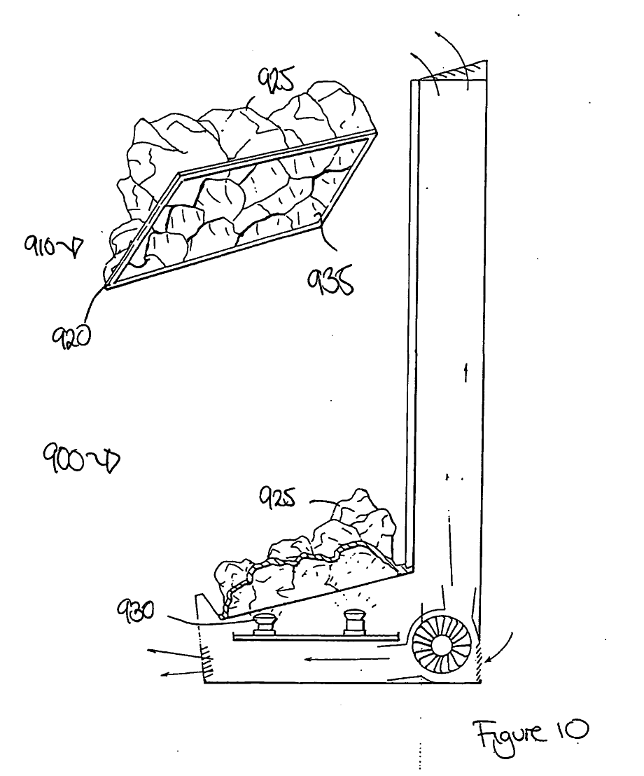

It will be recalled from the discussion of FIG. 1, that a fire of the invention includes a flame reflector. This could be provided in a traditional fashion or in accordance with the teachings of another aspect of the invention formed from a plastic substrate having a foil laminate formed thereon, the foil laminate being patterned to provide reflective surfaces. An example of such a flame reflector 800 is shown in FIG. 9. Desirably the foil laminate is formed on the plastic substrate using a hot foil stamping technique. The foil is typically selected from a brass and/or chrome metal foil. Such a technique is advantageous in that the design of the finished reflector is dictated by the pattern of the die used to stamp the foil and not the foil itself, and results in a number of “flames” 810 formed on the surface 820 of the substrate.

The substrate may be moulded to provide a textured surface which will provide a diffuse effect when illuminated with light. The substrate may also be formed as a flexible sheet, enabling the provision of the curved reflector. By using a mould to form the plastic substrate it is also possible to incorporate items such as mounting brackets as an integral component of the reflector.

In a further aspect of the invention shown in FIG. 10, an electric fire is provided having an artificial fuel bed 910, the fuel bed being formed from a moulded plastic substrate 920 having integrally formed on an upper surface thereof a plurality of individual raised protrusions 925. It will be appreciated that the protrusions replicate the effect provided by traditional fuel elements such as in this case coal or alternatively could be configured to dimension logs or indeed glass or pebbles in an artificial fuel bed. The number and individual dimensions of each of the protrusions may be predefined as part of the mould design process. Desirably the moulded plastic is formed from a polycarbonate or polypropylene resin. A colouring of the fuel bed may be achieved by varying the colour of the light source 930 used to illuminate the fuel bed or may alternatively or in addition be achieved by colouring the plastic fuel bed. An alternative embodiment could provide the desired colouring by applying a coloured filter to a lower surface 935 of the fuel bed prior to seating the bed above the lamps used to illuminate through the moulded bed.

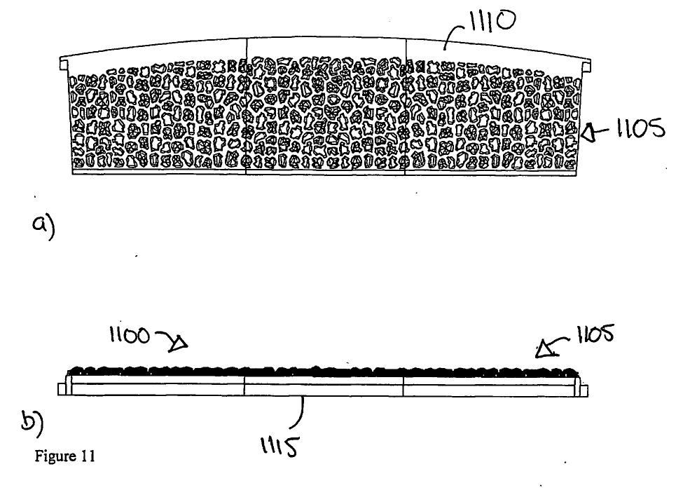

FIG. 11 shows another example of a fuel bed 1100 in accordance with an embodiment of the invention. FIG. 11a is a top view whereas FIG. 11b is a side view. It will be seen that the fabrication through a moulding or extrusion process of a number of protrusions 1105 which extend upwardly from a top surface 1110 of the substrate 1105 of the fuel bed may be used to simulate glass or pebbles that may traditionally have been manually placed on that surface. By colouring the polycarbonate or polypropylene that is used to fabricate the fuel bed the colour achieved may be altered. Alternatively as mentioned above with reference to FIG. 10, a filter may be placed or applied to a lower surface 1115 of the fuel bed.

It will be appreciated that a fire fabricated from a kit of parts has been disclosed. By forming housing components of the fire in a plastic moulding it is possible to provide integral structural mounts in the housing components which can easily receive additional smaller components required for the operation of the fire. The components are then assembled by first mounting them in their respective housings and then bringing the completed housings together to form the completed fire. With this process it is possible to reduce drastically the time required to fully assemble a fire.

By providing a fire of small dimensions and formed of plastics it is light and easy to transport and can fit in the smallest of areas. To make it compatible with larger fireplace openings, the invention in another embodiment has been described with reference to a fire surround or kit of parts which when assembled provide for an increase in the area of the façade of the fire, thereby enabling it to be placed in larger fireplaces without being dwarfed by the area in which it is located. This customization of the fire to the surroundings by the user is advantageous in that the user obtains a streamlined installed fire which aesthetically is presented as being integrally formed within the fireplace.

By fabricating the flame reflector using a hot foil technique it is possible to mould and form the substrate to a plurality of different configurations and achieve a number of patterns of flames on the substrate in a cost effective and efficient manner.

The provision of a polycarbonate fuel bed with the fuel elements being integrally formed during the manufacturing process again represents a departure from the traditional methods of fabricating such fire beds and reduces the danger of components of the bed separating from the bed. This is particularly useful if one considers the dangers of such components with small children.

These and other features of the invention have been described with reference to preferred embodiments but it will be appreciated that the invention has been described with reference to these as exemplary embodiments and it is not intended to limit the invention to any described embodiment except as may be deemed necessary in the light of the appended claims. Furthermore where combinations of features are described it will be appreciated that one or more features or components which are used in one embodiment may be interchanged or used in another embodiment without departing from the scope of the invention.

The words comprises/comprising when used in this specification are to specify the presence of stated features, integers, steps or components but does not preclude the presence or addition of one or more other features, integers, steps, components or groups thereof.

1. An electric fire comprising a front housing portion and a rear housing portion, the front and rear housing portions being separate and engageable and configured such that, once assembled, the outer surface of the fire is formed from the outer surfaces of each of the front and rear housing portions, the fire further including a blower housing portion and a rotisserie housing portion, each being mountable in an interior portion of the fire and not being visible from the exterior of the fire once the fire is assembled, and wherein each of the housing portions are fabricated in plastic and inter-engage with co-operating others of the housing portions through inter-engagement of parts integrally moulded in the housing portions.

2. The fire as claimed in claim 1 wherein at least some of the inter-engagement is effected using a snap-fit mating arrangement.

3. The fire as claimed in claim 1 wherein each of the housing portions are further moulded to provide integrally formed seats for receiving additional components required for operation of the fire.

4. The fire as claimed in claim 1 wherein the front housing portion is configured to receive and support inner and outer screen portions, the inner and outer screen portions being separated by a fuel bed located in a mid region of the front housing portion.

5. The fire as claimed in claim 4 wherein the inner screen portion is formed with an at least partially mirrored surface.

6. The fire as claimed in claim 3 further including a flame effect panel located behind the inner screen portion.

7. The fire as claimed in claim 6 wherein the flame effect panel is formed from a plastic substrate having a foil laminate formed thereon, the foil laminate providing a flame effect on the substrate.

8. The fire as claimed in claim 7 wherein the foil laminate is applied using a hot foil stamping technique.

9. The fire as claimed in claim 7 wherein the foil is formed using brass and/or chrome foil.

10. The fire as claimed in claim 7 wherein the laminate is formed from a multi-coloured material.

11. The fire as claimed in claim 7 wherein the substrate is provided with a textured surface so as to provide a diffuse effect when illuminate with light.

12. The fire as claimed in claim 7 wherein the substrate is formed as a flexible sheet, enabling the provision of a curved flame effect panel.

13. The fire as claimed in claim 7 wherein the substrate is moulded with integrally formed attachment means, configured to enable a mounting of the panel with the fire.

14. The fire as claimed in claim 1 further including an insert for increasing the area of the façade of an electric fire.

15. The fire as claimed in claim 14 wherein the insert is provided as a single sheet having an inner perimeter and outer perimeter, the distance between the inner perimeter and outer perimeter defining the area of the insert and wherein the inner perimeter is dimensioned to co-operate and mate with the façade of the fire, a mating of the inner perimeter with the façade increasing the area of the façade and enabling a closure of the opening within which the fire is located.

16. The fire as claimed in claim 14 wherein the insert is provided with a plurality of template cut lines, the template cut lines being arranged at different distances from the inner perimeter and providing a template for a user to cut the insert so as to reduce the area of the insert if so required to fit the opening available for the fire.

17. The fire as claimed in claim 14 wherein the insert is provided as a self-assembly kit, the kit enabling an enlarging of the area of the façade of the electric fire, the kit including a plurality of inter-connecting members, the members providing horizontal and vertical extensions which when interconnected with one another and coupled to the façade of the fire, increase the area of the façade thereby enabling a closing of the opening of the fireplace where the fire is located.

18. The fire as claimed in claim 17 wherein the insert members include at least two vertical members and one horizontal member which are configured such that when assembled, the vertical members provide an extension for the left and right side of the façade of the fire, the horizontal member provides an extension for the top of the façade, each of the two vertical members being coupled to respective ends of the horizontal members, the members serving to provide a frame about three sides of the façade of the fire.

19. The fire as claimed in claim 1 further including an artificial fuel bed, the fuel bed being formed from a moulded plastic substrate having integrally formed on an upper surface thereof a plurality of individual raised protrusions, the protrusions being configured to replicate the effect provided by fuel components in an artificial fuel bed.

20. The fire as claimed in claim 19 wherein the number and individual dimensions of each of the protrusions are predefined as part of the mould design process.

21. The fire as claimed in claim 19 wherein the moulded plastic is formed from a polycarbonate or polypropylene resin.

22. The fire as claimed in claim 19 wherein a colouring of the fuel bed may be achieved by varying the colour of the light source used to illuminate the fuel bed or may alternatively or in addition be achieved by colouring the plastic fuel bed or applying a colour filter between the fuel bed and the light source.

23-32. (canceled)
